(19) United States
(12) Patent Application Publication
(10) Pub. No.: US 2002/0089563 A1
(43) Pub. Date: Jul. 11, 2002

(54) Liquid-ejection recording head and ink-jet recorder

(76) Inventor: Shigeaki Tanaka, Tokyo (JP)

Correspondence Address: FITZPATRICK CELLA HARPER & SCINTO, 30 ROCKEFELLER PLAZA, NEW YORK, NY, 10112, US

(21) Appl. No.: 10/029,844

(22) Filed: Dec. 31, 2001

(30) Foreign Application Priority Data
Jan. 10, 2001 (JP) 2001-002345

(51) Int. Cl. B41J 2/015

(52) U.S. Cl. 347/20

(57) ABSTRACT

In a serial ink-jet recorder in which recording is performed by moving a liquid-ejection recording head including means for discharging a recording liquid from at least one discharging port, an air-flow inlet having an opening in the moving direction of the recording head is formed. Air introduced from the air-flow inlet is discharged from a discharging port provided before the discharging port in the moving direction of the recording head, in the same direction as the direction of ink discharge of the recording head. It is thereby possible to protect fine ink dust other than main ink droplets from a high-speed air flow, and prevent wide dispersion of the ink dust.

### BACKGROUND OF THE INVENTION

1. Field of the Invention

The present invention relates to a liquid-ejection recording head in which fine ink droplets are discharged, and ink-jet recorder including such a recording head, from among non-impact recorders.

2. Description of the Related Art

In the field of serial ink-jet recording in which recording is performed by moving a recording head on a recording medium, a request for higher-speed output is increasing. As a result, the moving (scanning) speed of the head is also increasing. In general, when ink droplets are discharged from a recording head moving at a high speed, fine ink droplets (mist, also called dust) are also generated together with the main ink droplet. Such fine ink droplets are smaller than a small droplet (a so-called satellite droplet) generated together with the main droplet such that they cannot be observed when they reach a recording medium. Such ink main droplets, satellite droplets and fine ink droplets are influenced by the flow of air generated depending on the moving speed of the recording head and entering a portion between the surface of ink discharging ports of the recording head and the recording medium.

Ink dust (mist) comprising fine ink droplets smaller than main droplets and satellite droplets, such as fine ink droplets generated together with main droplets, rebound fine droplets generated when main droplets and satellite droplets arrive the recording medium, and the like, is greatly influenced by an air flow generated by scanning of the recording head in horizontal directions. That is, while ink main droplets and satellite droplets reach the recording medium without being greatly influenced by the air flow, the ink dust is raised by the air flow, adheres to the inside of the ink-jet recorder, and again adheres to the surface of ink discharging ports of the recording head. Although the fine droplets are very small, they gradually stain the inside of the ink-jet recorder during the use of the recorder, and degrade the state of the surface of ink-discharging ports of the recording head. As a result, the life of the recording head is greatly shortened.

### SUMMARY OF THE INVENTION

The present invention has been made in consideration of the above-described problems.

It is an object of the present invention to provide an ink-jet recording head and an ink-jet recorder which can protect fine ink dust other than main droplets from a high-speed air flow, and prevent wide diffusion of the ink dust.

According to one aspect, the present invention which achieves the above-described object relates to a liquid-ejection recording head for performing recording by moving while facing a recording medium, and discharging a liquid from at least one discharging port. The liquid-ejection recording head includes an air-flow inlet opening in a moving direction of the liquid-ejection recording head, and an air discharging port for discharging air introduced from the air-flow inlet, to a region before a region between the discharging port and the recording medium with respect to the moving direction of the liquid-ejection recording head.

According to another aspect, the present invention which achieves the above-described object relates to an ink-jet recorder including a carriage mountable the above-described liquid-ejection recording head. The carriage is detachably mountable the liquid-ejection recording head.

According to still another aspect, the present invention which achieves the above-described object relates to an ink-jet recorder including a carriage mountable a liquid-ejection recording head for performing recording by moving on a recording medium and discharging a liquid from the recording head. The carriage includes an air-flow inlet including an opening in a moving direction of the carriage, and an air discharging port for discharging air introduced from the air-flow inlet, to a region before a region between a discharging port and the recording medium with respect to a moving direction of the liquid-ejection recording head.

According to the above-described configuration, it is possible to form an air barrier, make accuracy in arrival of a main droplet very high, protect fine ink dust other than the main droplet from a high-speed air flow, and prevent wide dispersion of the ink dust. As a result, it is possible to prevent stain within the ink-jet recorder, and achieve a long life of the recording head caused by prevention of stain of the surface of discharging ports of the recording head.

The foregoing and other objects, advantages and features of the present invention will become more apparent from the following detailed description of the preferred embodiments taken in conjunction with the accompanying drawings.

### BRIEF DESCRIPTION OF THE DRAWINGS

FIG. 1 is a cross-sectional view of a recording head of an ink-jet recorder according to a first embodiment of the present invention;

FIG. 2 is a cross-sectional view of a recording head of an ink-jet recorder according to a second embodiment of the present invention;

FIG. 3 is a cross-sectional view of a recording head of an ink-jet recorder according to a third embodiment of the present invention;

FIG. 4 is a cross-sectional view of a recording head of an ink-jet recorder according to a fourth embodiment of the present invention; and

FIG. 5 is a schematic perspective view of an ink-jet recorder according to the present invention.

### DETAILED DESCRIPTION OF THE PREFERRED EMBODIMENTS

Preferred embodiments of the present invention will now be described in detail with reference to the drawings.

(First Embodiment)

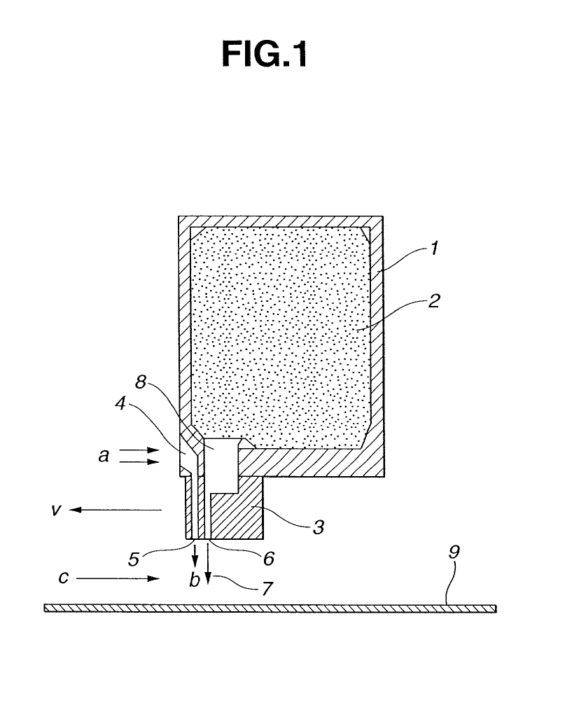

FIG. 1 is a cross-sectional view of a recording head of an ink-jet recorder according to a first embodiment of the present invention. The recording head shown in FIG. 1 is a serial recording head for one-direction printing in which a discharging unit and an ink tank are integrated.

In FIG. 1, there are shown a recoding-head ink tank (ink-jet cartridge) 1, an ink absorber for holding ink within the ink-jet cartridge 1, and a recording-head discharging unit 3 including a discharging mechanism.

Ink is discharged according to various methods, such as a method in which ink is discharged due to a change in the volume by generating a bubble in the ink by supplying a heating member with electric power, a method in which ink is discharged due to a change in the volume caused by deformation of a piezoelectric element, and the like. In the present invention, however, the discharging method is not particularly important. The effects of the present invention can be obtained irrespective of the mechanism and the method of ink discharge.

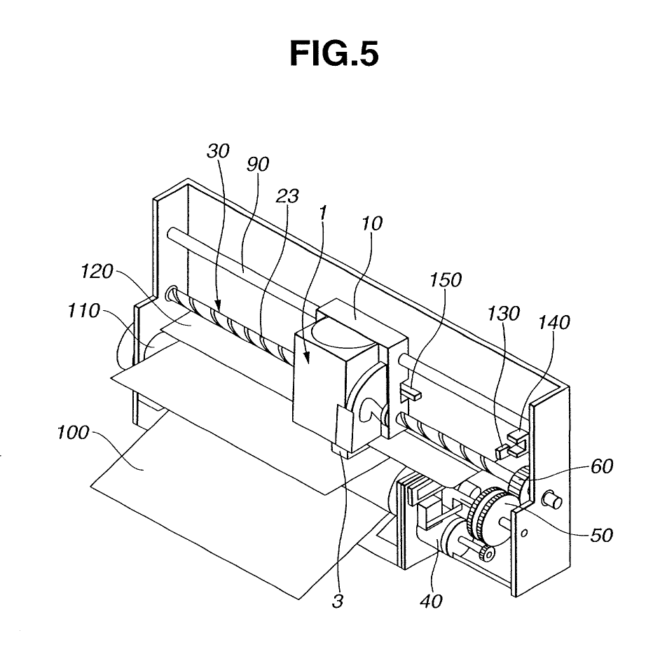

In FIG. 1, reference numeral 8 represents an ink supply unit. The ink supply unit 8 introduces ink from the ink absorber 2, and discharges the ink from a discharging port 6 utilizing an ink discharging mechanism, to cause the ink to reach a recording medium 9. Although the details will be described later with reference to FIG. 5, the ink-jet cartridge 1 is disposed so as to be able to scan the recording medium in horizontal directions by being mounted on a carriage 10 of the ink-jet recorder.

In FIG. 1, an arrow v indicates the moving direction of the recording head during printing. Air enters a portion between the surface of the recording head and the recording medium 9 in the direction of an arrow c that is opposite to the moving direction of the recording head.

Reference numeral 4 represents an air-flow inlet provided at a front side of the ink-jet cartridge 1 in the moving direction. In accordance with the movement of the recording head, air enters from the direction of arrows “a”, and is discharged in the direction of an arrow b, that is the same as the discharging direction of an ink droplet, from an air discharging port 5. Entrance of air in the direction c is suppressed by the flow of the discharged air. More specifically, a so-called air curtain (air barrier) is formed due to the air flow in the direction b discharged from the air discharging port 5. By thus forming the barrier for entrance of the air flow in the direction c caused by the movement of the recording-head cartridge 1, influence of the air flow in the direction c on a discharged ink droplet 7 can be mitigated. Accordingly, the discharged ink droplet 7 reaches a predetermined position on the recording medium, and fine ink droplets generated together with the main droplet can also reach a position near the main droplet without being influenced by the air flow in the direction c. It is thereby possible to prevent degradation of recording quality due to dispersion of the fine ink droplets, and stain on the inside of the recorder and the surface of the recording head. Since the fine droplets (dust) that have reached the recording medium are very small, they cannot be observed after printing. According to the above-described simple configuration that the air-flow inlet is provided at the side of the recording head, it is possible to achieve provision of a mechanism of introducing and discharging air linked with the movement of the carriage.

The air discharging port 5 is preferably disposed near the discharging port 6 of the recording head, as in the first embodiment. If the air discharging port 5 is too close to the discharging port 6, discharged ink droplets are influenced by air from the air discharging port 5, thereby degrading the direction of ink discharge. If the air discharging port 5 is too remote from the discharging port 6, the effect of the air curtain is degraded. It is preferable to dispose the air discharging port 5 on the same surface as the discharging port 6 as in the first embodiment, or at a position adjacent to the surface of discharging ports as in an embodiment to be described later.

Although not illustrated, it is preferable that the length of the air discharging port 5 to the surface of the discharging port is equal to or more or less larger than the length of the discharging port 6, in consideration of the effect of the air curtain.

As shown in FIG. 1, it is preferable that the cross section gradually decreases from the air-flow inlet 4 to the air discharging port 5. By making the air-flow inlet 4 large to a certain degree, air can be efficiently introduced together with the movement of the carriage, and by gradually decreasing the cross section, the velocity of the air flow can be increased, thereby improving the effect of the air curtain.

(Second Embodiment)

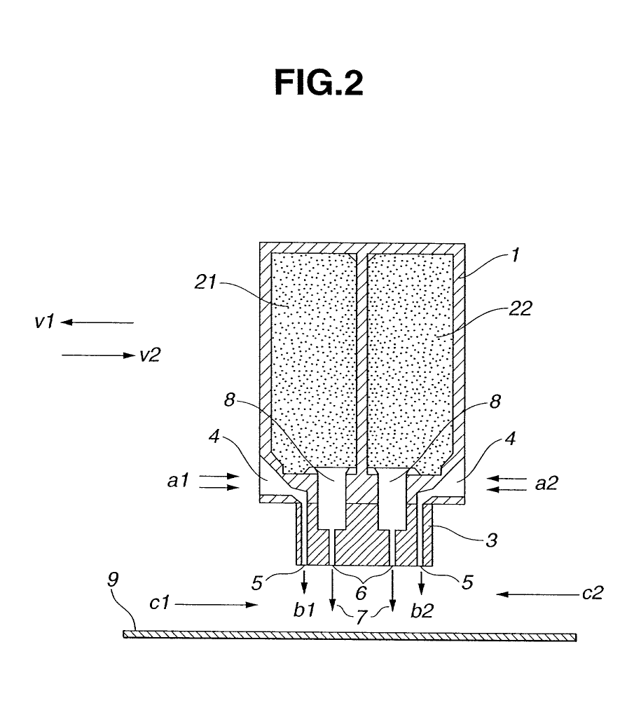

FIG. 2 is a cross-sectional view of a recording head of an ink-jet recorder according to a second embodiment of the present invention. In the recording head shown in FIG. 2, integrated sets of a discharging unit and an ink tank are provided. That is, the recording head includes a plurality of ink tanks having different types of ink and a plurality of ink-jet heads for discharging corresponding ink liquids. The recording head of the second embodiment can perform reciprocating printing.

In FIG. 2, there are shown a recoding-head ink tank (ink cartridge) 1, ink absorbers 21 and 22, each for holding ink within the ink tank 1, and a recording-head discharging unit 3 including a discharging mechanism.

In FIG. 2, reference numeral 8 represents an ink supply unit. The ink supply unit 8 introduces ink liquids from the ink absorbers 21 and 22, and discharges the ink liquids from discharging ports 6 utilizing an ink discharging mechanism, to cause the ink liquids to reach a recording medium 9.

In FIG. 2, arrows v1 and v2 indicate the moving directions of the recording head during printing. Air enters a portion between the surface of the recording head and the recording medium 9 in the directions of arrows c1 and c2 that are opposite to the moving directions of the recording head.

Reference numeral 4 represents an air-flow inlet. When the recording head moves in the direction v1 during printing, air enters from the direction of arrows a1, and is discharged from an air discharging port 5 in the direction of an arrow b, that is the same as the discharging direction of an ink droplet. When the recording head moves in the direction v2, air enters from the direction of arrows a2, and is discharged from the air discharging port 5 in the direction of the arrow b. As in the above-described first embodiment, entrance of air into a portion between the surface of the recording head and the recording medium 9 in the directions c1 and c2 is suppressed by the flow of the discharged air. By thus providing air discharging ports at portions before the discharging ports 5 with respect to the moving directions of the recording head, it is possible to prevent dispersion of fine droplets in the recorder capable of performing reciprocating printing, as in the first embodiment.

(Third Embodiment)

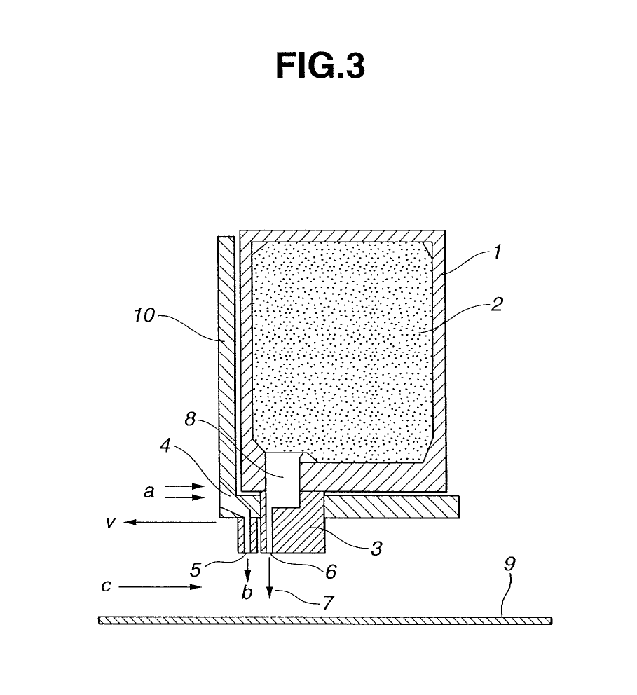

FIG. 3 is a cross-sectional view of a recording head of an ink-jet recorder according to a third embodiment of the present invention. In the recording head shown in FIG. 3, a discharging unit and an ink tank are integrated. FIG. 3 illustrates a state in which a serial recording head for performing one-direction printing is mounted on a carriage, serving as a head mounting member of the ink-jet recorder

In FIG. 3, there are shown a recoding-head ink tank 1, an ink absorber for holding ink within the ink tank 1, and a recording-head discharging unit 3 including a discharging mechanism

The basic configuration and the functions of this recording head are the same as in the first embodiment. The third embodiment differs from the first embodiment in that an air-flow inlet 4 is provided in a carriage 10.

Even if the air-flow inlet 4 is provided in the carriage 10 as in the third embodiment, by discharging air in the same direction as an ink droplet from a discharging port 5 by the movement of the carriage 10 in a horizontal direction, as in the first embodiment, to provide the role of an air curtain, wide dispersion of fine ink droplets can be prevented. When an air discharging port is provided in the carriage, it is also preferable to dispose the discharging port at a position adjacent to an ink discharging nozzle 6. Although in the third embodiment, printing in one direction has been described, the present invention is not limited to such a case. The present invention may also be applied to printing in two directions as in the second embodiment.

(Fourth Embodiment)

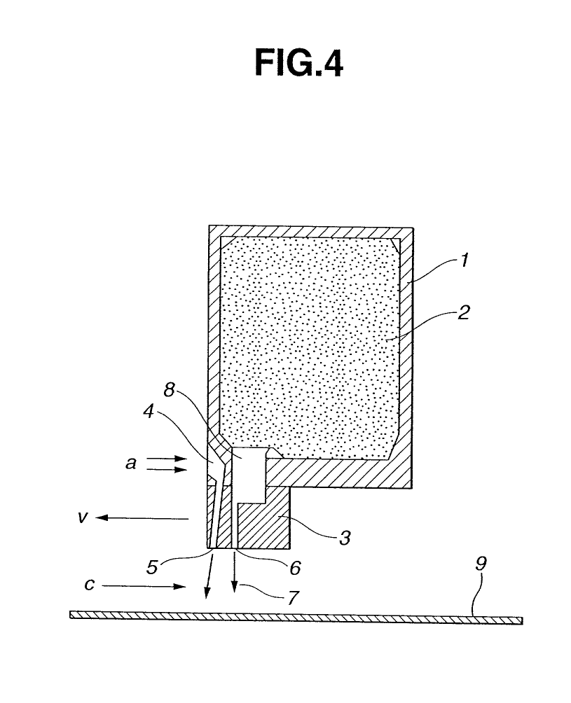

FIG. 4 is a cross-sectional view of a recording head of an ink-jet recorder according to a fourth embodiment of the present invention. Although the fourth embodiment is the same as the above-described first and second embodiments in that an air-flow inlet 4 is provided in a recording-head cartridge 1, the fourth embodiment differs from the first and second embodiments in that the direction of air discharge differs from the direction of ink discharge.

More specifically, in the fourth embodiment, air entering from the air-flow inlet 4 is discharged by being inclined in a direction separated from the discharging direction of ink droplets, instead of being discharged substantially parallel to the discharging direction of ink droplets. Thus, it is possible to assuredly prevent air discharged from the air discharging port 5 from badly influencing the direction of discharged ink droplets while suppressing influence of air flow in the direction of an arrow c caused by the movement of the recording head. It is thereby possible to prevent dispersion of fine ink droplets, and very precisely maintain the position of arrival of an ink droplet (a main droplet).

Although not described in the foregoing embodiments, the air-flow inlet 4 and the air discharging port 5 may be formed in an ink-tank holder having a recording head that is disposed so as to be replaced with respect to the carriage. In this case, the ink tank is disposed so as to be replaceable with respect to the ink-tank holder.

Although the present invention has been described illustrating the first through fourth embodiments, the above-described embodiments may be appropriately combined.

FIG. 5 is a schematic perspective view illustrating the configuration of an ink-jet recorder according to the present invention. In FIG. 5, a lead screw 30 having a helical groove (lead groove) 23 on the circumferential surface thereof is rotatably supported on the main body of the recorder. The lead screw 30 is linked with forward/reverse rotation of a driving motor 40 so as to be rotatably driven via transmission gears 50 and 60. A carriage 10 is fitted to the lead screw 30 in a state in which a pin (not shown) provided on a supporting portion of the carriage 10 is fitted in the helical groove 23, and is also slidably supported on a guide rail 90 so as to be reciprocated in accordance with forward/reverse rotation of the driving motor 40.

A recording material 100, such as paper, a plastic thin film, or the like, is fed by a platen roller, and is pressed against the circumferential surface of a platen 110 at a recording position by a sheet pressing plate 120 extending in the moving direction of the carriage 10. A photocoupler 130, 140 serves as home-position detection means for confirming presence of a lever 150 of the carriage 10 in this region and causing the driving motor 40, for example, to revolve in a reverse direction. Ink-jet recording means 16 is mounted on the carriage 10. Although in this configuration, scanning by the carriage 10 using the lead screw 30 has been described, the present invention is not limited to such an approach. The present invention may also be applied to an ordinary serial ink-jet recorder performing, for example, scanning of a carriage using a belt.

As is apparent from the foregoing description, according to the present invention, in a serial ink-jet recorder in which recording is performed by movement of a liquid-ejection recording head having means for discharging ink from an ink-discharging port of the recording head, an air-flow inlet having an opening in the moving direction of the recording head is formed in the recording head, and air introduced from the air-flow inlet is discharged from a discharging port provided at a portion before the ink-discharging port in the moving direction of the recording head, in a direction substantially parallel to the direction of ink discharge of the recording head. As a result, it is possible to make accuracy in arrival of a main droplet high, protect fine ink dust other than the main droplet from a high-speed air flow, and prevent wide dispersion of the ink dust.

The individual components shown in outline in the drawings are all well known in the liquid-ejection recording head and ink-jet recorder arts and their specific construction and operation are not critical to the operation or the best mode for carrying out the invention.

While the present invention has been described with respect to what are presently considered to be the preferred embodiments, it is to be understood that the invention is not limited to the disclosed embodiments. To the contrary, the present invention is intended to cover various modifications and equivalent arrangements included within the spirit and scope of the appended claims. The scope of the following claims is to be accorded the broadest interpretation so as to encompass all such modifications and equivalent structures and functions.

What is claimed is:

1. A liquid-ejection recording head for performing recording by moving while facing a recording medium, and discharging a liquid from at least one discharging port, said liquid-ejection recording head comprising:
an air-flow inlet opening in a moving direction of said liquid-ejection recording head; and
an air discharging port for discharging air introduced from said air-flow inlet, to a region before a region between the discharging port and the recording medium with respect to the moving direction of said liquid-ejection recording head.

2. A liquid-ejection recording head according to claim 1, wherein said air discharging port is disposed near the discharging port of said liquid-ejection recording head, on the same plane as the discharging port.

3. A liquid-ejection recording head according to claim 1, wherein the air is discharged from said air discharging port toward the recording medium in order to prevent an air flow entering a portion between a surface of the discharging port and the recording medium caused by movement of said liquid-ejection recording head.

4. A liquid-ejection recording head according to claim 1, wherein the air is discharged from said air discharging port in a direction substantially parallel to a discharging direction of an ink droplet discharged from the discharging port.

5. A liquid-ejection recording head according to claim 1, wherein the air is discharged from said air discharging port in a direction separated from an ink droplet discharged from the discharging port.

6. A liquid-ejection recording head according to claim 1, wherein a length of said air discharging port in a longitudinal direction is equal to or larger than a length of a discharging-port column of said liquid-ejection recording head.

7. An ink-jet recorder comprising:
a carriage mountable said liquid-ejection recording head according to claim 1,
wherein said carriage is detachably mountable said liquid-ejection recording head.

8. An ink-jet recorder including a carriage mountable a liquid-ejection recording head for performing recording by moving on a recording medium and discharging a liquid from the recording head, said carriage comprising:
an air-flow inlet including an opening in a moving direction of said carriage; and
an air discharging port for discharging air introduced from said air-flow inlet, to a region before a region between a discharging port and the recording medium with respect to a moving direction of said liquid-ejection recording head.

9. An ink-jet recorder according to claim 8, wherein the air is discharged from said air discharging port toward the recording medium in order to prevent an air flow entering a portion between a surface of the discharging port and the recording medium caused by movement of said liquid-ejection recording head.

10. An ink-jet recorder according to claim 8, wherein a length of said air discharging port in a longitudinal direction is equal to or larger than a length of a discharging-port column of said liquid-ejection recording head.
